(19) United States
(12) Patent Application Publication
(10) Pub. No.: US 2012/0179527 A1
(43) Pub. Date: Jul. 12, 2012

(54) METHOD OF DELIVERING EFFECTIVE MOBILE ADVERTISING

(76) Inventors: Zachary W. Ball, Oak Park, MI (US); Joshua L. Ball, Waterford, MI (US); Michael H. Gauthier, Rochester, MI (US)

(21) Appl. No.: 13/345,678

(22) Filed: Jan. 7, 2012

Related U.S. Application Data
(60) Provisional application No. 61/430,849, filed on Jan. 7, 2011.
(60) Provisional application No. 61/482,593, filed on May 4, 2011.
(60) Provisional application No. 61/494,853, filed on Jun. 8, 2011.
(60) Provisional application No. 61/510,042, filed on Jul. 20, 2011.
(60) Provisional application No. 61/525,141, filed on Aug. 18, 2011.

(51) Int. Cl. G06Q 30/02

(52) U.S. Cl. 705/14.17; 705/14.58; 705/14.1

(57) ABSTRACT

Provided herein is a method of delivering an advertisement to at least one mobile device which includes a software application that is operable on mobile devices. Also provided is a software interface that works in conjunction with the mobile software application. The software interface operates on a network server accessible to a computer network, such as the Internet. The method includes the step of defining a geographic location for delivery of the advertisements. The software interface then transmits the advertisement to at least one mobile device operating the mobile software application which is located within the geographic location. An incentive is then provided to the user of the mobile which has received the advertisement. The incentive may optionally comprise a monetary payment to the user of the mobile device.

### CROSS-REFERENCE TO RELATED APPLICATIONS

This application claims the benefit of: U.S. Provisional Application 61/430,849, which was filed on Jan. 7, 2011; U.S. Provisional Application 61/482,593, which was filed on May 4, 2011; U.S. Provisional Application 61/494,853, which was filed on Jun. 8, 2011; U.S. Provisional Application 61/510,042, which was filed on Jul. 20, 2011; and U.S. Provisional Application 61/525,141, which was filed on Aug. 18, 2011, the disclosures of which are hereby incorporated by reference.

### BACKGROUND OF THE INVENTION

1. Field of the Invention

The present invention pertains to a method of delivering effective mobile advertising. More particularly, the present invention pertains to a method of delivering effective mobile advertising within a pre-defined geographic location. Even more particularly, the present invention pertains to a method of delivering effective mobile advertising to a mobile device within a pre-defined geographic location by providing the user with an incentive of known value for viewing the advertisement. According to a preferred embodiment, the user is provided with a monetary payment from the advertiser after viewing the ad.

2. Description of the Prior Art

The delivery of advertising to geospecific locations is known in the prior art, as disclosed by U.S. Pat. No. 7,814,106 to Guido et al. Guido discloses a method of facilitating delivery of advertising to users of mobile computing platforms based on their location. A geographic database is provided which contains entities that represent geographic features, such as roads, which are located within the geographic region. Data is associated with at least some of the entities that are known to be located within specified advertising zones. Users of mobile computing platforms are provided with geographically-related services that use the geographic database. As a user of a mobile computing platform travels within the geographic region, the location of the mobile computing platform is determined. The user of the mobile computing platform is provided with the advertising message associated with the advertising zone in which the mobile computing platform is determined to be located. Thus, advertisers are able to direct their advertisements to only those in the area in which they have specified.

In addition, there exists a mobile advertising delivery service marketed under the trademark Brightkite®. Brightkite® is an application on a mobile computing platform which interfaces between the user and the advertiser. Brightkite® utilizes just-in-time advertising methods to deliver advertisements to mobile computing platforms within specific geographic locations. Brightkite® can also specify the delivery of advertisements based on parameters such as the weather or the time of day. It can further allow advertisers to define their target audience by using traditional known demographics, as well as users' previous known behavior and activities.

For instance, Brightkite® can deliver auto dealership ads to only those users located within three miles of a dealership during business hours on the weekend. Brightkite® can also deliver e-coupons for free food or beverages to users who are located within two miles of a specific restaurant from the hours of 11:00 AM to 2:00 PM during the work week. Brightkite® further can provide advertisements to users for a $10 coupon at a specific store, so long as the user performs some required action, such as posting their location on a social media website or texting their location to a specified number of people once they have arrived at the store.

However, the crux of services such as Brightkite® is that, once the user has downloaded and is using the application, it is the advertisers who determine what ads are delivered to the users. The users are left with little incentive to check every advertisement because so many ads may be of little interest. Thus, in the end, the users may come to view these types of services as a burden rather than a means for receiving a benefit. Furthermore, when the advertisement requires the user to take a specific action, such as posting their location to a website or texting their friends, the activity may be counterproductive to the advertising campaign because the user may feel overtly commercialized, or feel as though they are burdening their friends for a selfish benefit. In addition, many people may simply prefer to not broadcast that they ate lunch at a restaurant because they received a free beverage.

Thus, there remains a need for a geographically-specific mobile advertising service which ensures that the advertiser's target audience is actually viewing the ad at a specific time and/or location in order to quickly and efficiently attract a large number of customers.

The present invention, as is detailed hereinbelow, seeks to resolve these issues by providing a method of delivering effective mobile advertising to a mobile device within a pre-defined geographic location by providing the user with an incentive of known value for viewing the advertisement.

### SUMMARY OF THE INVENTION

In a first embodiment hereof, the present invention provides a method of delivering an advertisement to at least one mobile device which generally comprises:
(a) providing a software application which is operable on the at least one mobile device;
(b) defining a geographic location;
(c) transmitting the advertisement to the at least one mobile device operating the software which is located within the geographic location; and
(d) providing an incentive to each user of the at least one mobile device.

According to this embodiment, rather than providing the incentive to the user for viewing the advertisement, optionally the incentive can be provided to the user for simply receiving the advertisement.

According to a preferred embodiment hereof, the incentive is preferably a payment to the user of the mobile device.

In a second embodiment hereof, the present invention provides a method of delivering an advertisement to at least one mobile device which generally comprises:
(a) providing a software application which is operable on the at least one mobile device;
(b) transmitting the advertisement to the at least one mobile device operating the software; and
(c) providing an incentive to each user of the at least one mobile device.

In a third embodiment hereof, the present invention provides a method of delivering an advertisement to at least one mobile device which generally comprises:
(a) defining a geographic location for delivery of the advertisement;
(b) transmitting the advertisement to each mobile device which enters into the geographic location; and
(c) providing an incentive to a user of the mobile device for viewing the advertisement.

In a fourth embodiment hereof, the present invention provides a method of delivering an advertisement to at least one mobile device which generally comprises:
(a) defining a geographic location for delivery of the advertisement;
(b) transmitting the advertisement to any provided mobile device located within the geographic location; and
(c) transmitting the advertisement to each mobile device which enters into the geographic location.

In a fifth embodiment hereof, the present invention provides a method of delivering an advertisement to at least one mobile device which generally comprises:
(a) transmitting the advertisement to any provided mobile device; and
(b) displaying a dynamic countdown to an expiration of the advertisement on the mobile device.

In a sixth embodiment hereof, the present invention provides a method of delivering an advertisement to at least one mobile device which generally comprises:
(a) transmitting the advertisement to any provided mobile device;
(b) displaying an ad image on the mobile device, the ad image including information relevant to the advertisement to inform a user as to the content and expiration date of the advertisement; and
(c) displaying a redeem image on the mobile device, the redeem image containing redemption information necessary to redeem the advertisement.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is a schematic view of a first embodiment of the present invention hereof;

FIG. 2 is a schematic view of a second embodiment of the present invention;

FIG. 3 is a schematic view of a third embodiment of the present invention;

FIG. 4 is a schematic view of a fourth embodiment of the present invention;

FIG. 5 is an exemplary view of a countdown timer being displayed on a mobile device according to a fifth embodiment of the present invention;

FIG. 6 is a flowchart according to the first embodiment of the present invention;

FIG. 7 is a flowchart according to the second embodiment of the present invention;

FIG. 8 is a flowchart according to the sixth embodiment of the present invention; and

FIG. 9 shows an embodiment of the invention utilizing a child location for triggering the delivery of the advertisement and a parent location for specifying the location that the advertisement can be redeemed.

### DETAILED DESCRIPTION OF THE PREFERRED EMBODIMENT

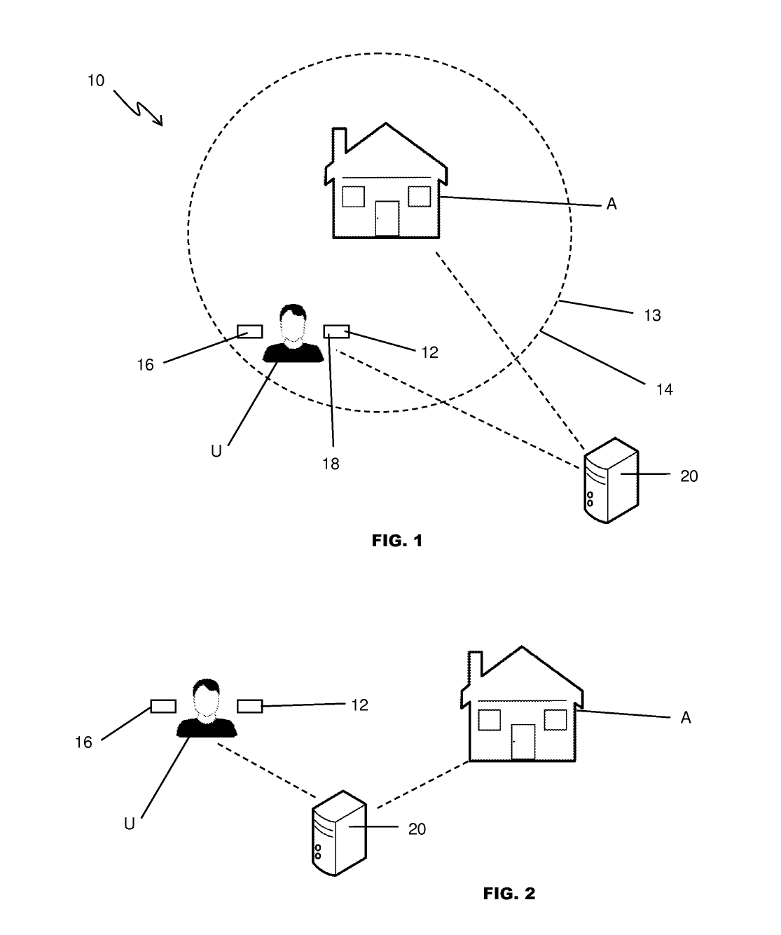

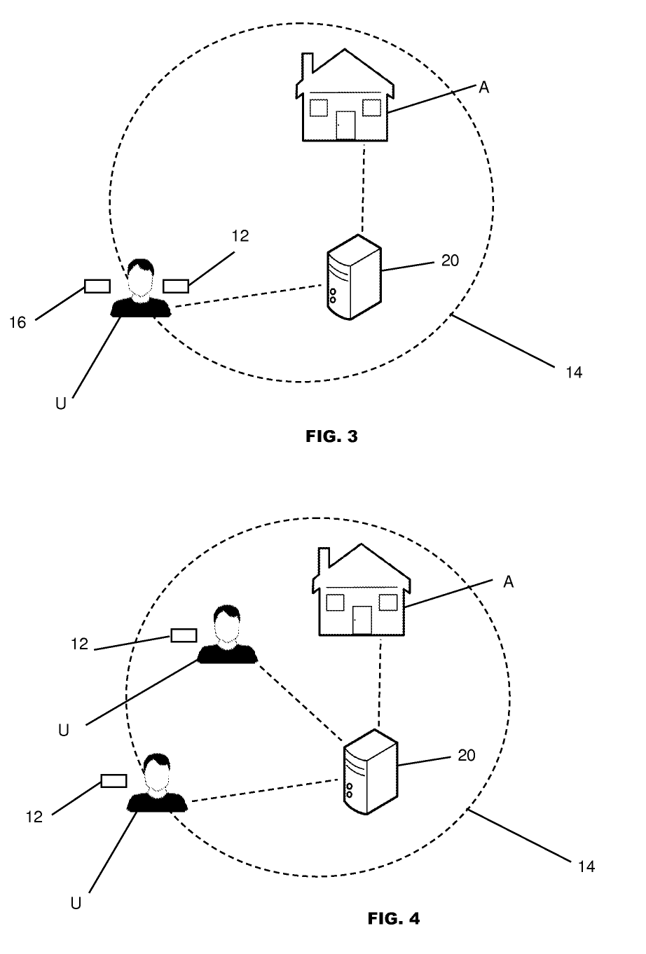

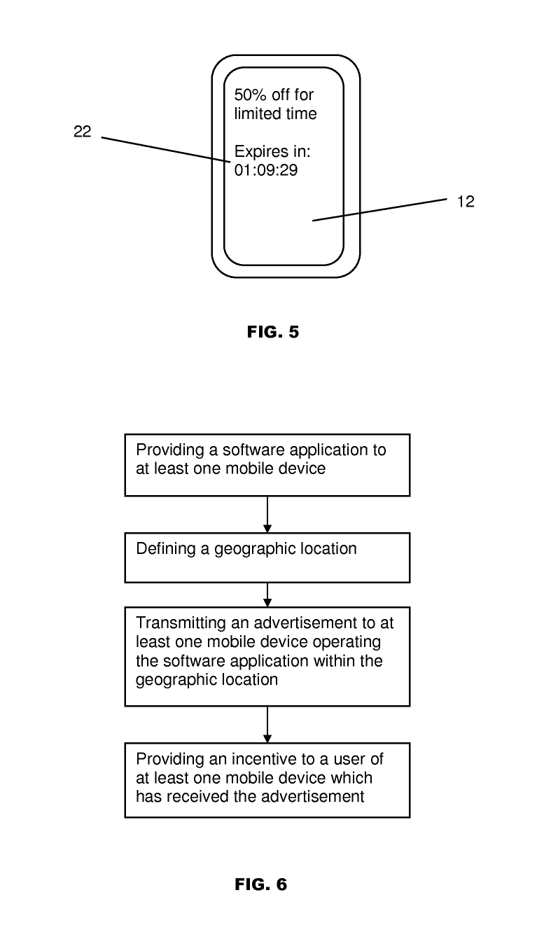

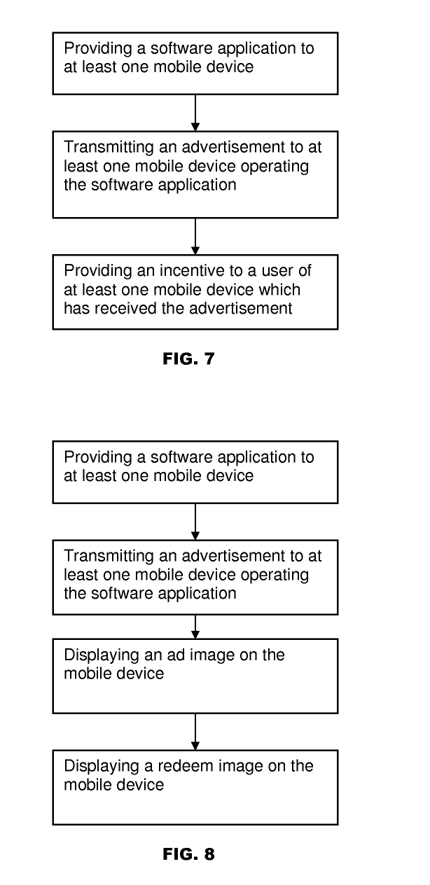

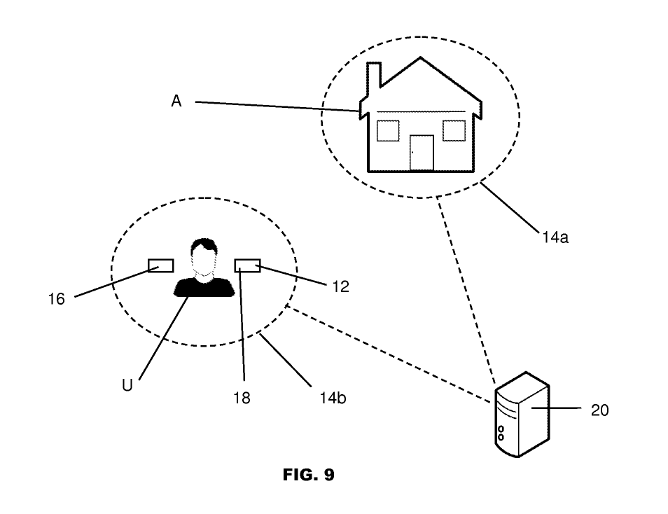

In accordance with the present invention and as shown generally in FIG. 1, there is provided a method of delivering an advertisement, denoted generally at 10, to at least one mobile device 12 which generally comprises: (a) defining a geographic location 14 for delivery of the advertisement; (b) transmitting the advertisement to any provided mobile device 12 located within the geographic location 14; and (c) providing an incentive 16 of known value to a user U of the mobile device 12 for viewing the advertisement. Preferably, although not necessarily, the incentive 16 is a monetary payment to the user U.

The mobile device 12, as referenced herein, can comprise any suitable type of mobile apparatus capable of receiving transmitted signals, such as a mobile phone. Preferably, the mobile device 12 is capable of determining its location, such as through GPS, a triangulation calculation using signals sent from geographically known sources, or any other suitable means which are well-known in the art. Alternatively, the mobile device 12 can provide adequate information to other devices which allow the other devices to determine the location of the mobile device 12 and then transmit the known location back to the mobile device 12.

Preferably the mobile device 12 is also capable of downloading and installing programmable applications. It is contemplated that the present invention includes, and is operable through, a software program which includes a downloadable application 18 which operates on a mobile device 12. Current examples of a suitable mobile device 12 can include smart phones, such as the iPhone®, Blackberry®, and Android®; tablet computers like the iPad®; typical laptop computers; or any other suitable type of mobile computing device. It is assumed that mobile devices which are suitable for use herewith will continue to be developed, and thus the invention is not intended to be limited with respect to the specific devices above. The present invention can be used with any suitable type of mobile device 12 which is well-known to one having ordinary skill in the art, including those which have not yet been invented or developed at this time. Due to their inherent mobility, the mobile device 12 is preferably a smart phone.

The present invention can also include an application interface 20 through which the advertiser A can configure its advertisement. As referenced herein, “advertisement” can mean an ad displaying a store name or service provider, a coupon, a voucher, a sale, and so forth. The interface 20 preferably comprises a web-based program accessible virtually anywhere using any suitable type of web browser or mobile computing platform. In this instance, the interface 20 is loaded onto a web server and is accessible anywhere through the Internet. The interface 20 can alternatively operate as a CPU-based program. However, as described below, it is envisioned that the interface 20 is preferably operated through a central server which is run and maintained by a single central service provider. The interface 20 interacts in coordination with the downloadable application 18 on the mobile device 12 to communicate therebetween. The interface 20 and the application 18 can communicate with each other using any suitable means, including but not limited to, the Internet and/or telecommunication networks, such as the type having 3G or 4G capability.

Using the interface 20, an advertiser A can configure an advertising campaign for delivery to the mobile device 12. The advertising parameters 13 selectable by the advertiser A can include the content of the ad, the geographic location 14 for delivery, specific dates and/or times for delivery, an expiration, and so forth. As described in further detail below, the expiration can be based upon an expiration date, a finite number of advertisements which will be redeemed, and so forth. The parameters 13 can also include any demographic information for delivery to specific people, such as by sex, age, religion, political affiliation, education level, race, income level, location and/or region of residence, and so forth. It is anticipated that this information could be available to advertisers through data collection services.

This information may also be supplied by the user U when installing and configuring the programmable application 18 to their mobile device 12 to receive specific types of advertisements. The user U may be able to provide as much or as little information about themselves as they desire. Additionally, the user U may be able to select specific types of goods or services for which they are interested in receiving advertisements. Even more specifically, the user U may be able to select specific companies or retailers with whom they are only interested in receiving advertisements from. Allowing the user U to somewhat control the types of ads delivered to them will make the user U more likely to view the ad.

The parameters 13 discussed above comprise a non-limiting list, and can include any type of information which is capable of assisting advertisers in providing users with advertisements that are specific to their anticipated needs. It is believed that as technology and means for communication improves, advertising in general will become more and more personalized for the intended audience.

One such parameter 13 that is utilized in the first embodiment of the present invention is the geographic location 14 for delivery of the mobile advertisement. The geographic location 14 can be defined by the advertiser A according to any suitable method. For instance, the geographic location 14 for delivering an ad can be defined by an area code, a city limit, zip code, a defined radius about a specific location, an address, and so forth. It is anticipated that as technology progresses, the level of geographic specificity can be defined more and more accurately as well.

Optionally, and as shown in FIG. 9, the invention can be utilized in a manner in which there is an object (or parent) geographic location 14a and a trigger (or child) geographic location 14b. In this instance, the parent location 14a may function in a manner described above in which the mobile device 12 receives the advertisement when it enters the specified boundary of the parent location 14a. The parent location 14a is a location to which the advertisement pertains. That is, the coupon, voucher, sale, etc. can be redeemed for value at the parent location 14a. Although the parent location 14a can be a physical brick-and-mortar store, it can also be an online location like a website. When the parent location 14a is an online-only location, it is apparent that the parent location 14a does not have a geographic location 14 per se, but that the advertisement can be delivered, for example, when the user U accesses a specific website (e.g., the advertiser's or their competitor's).

Conversely, the child location 14b may be defined as any geographic location as desired by the advertiser A. Unlike the parent location 14a, the child location 14b is not necessarily a location where the advertisement can be redeemed. The child location 14b is intended to be any arbitrary location as specified by the advertiser A. For instance, the child location 14b can be the physical location of a competitor. In this regard, the advertiser A can set up the advertisement to deliver the ad to the mobile device 12 of potential customers to offer the user U a sale or exclusive offer in order to detract the user's business from the competitor to the advertiser A.

In another example of how the parameters 13 can be configured, envision that the advertiser A provides an on-site product or service, such as a roofing company. Using this example, the child location 14b could be set up at one of the advertiser's job sites. As each user U enters the boundary of the child location 14b, the advertisement is delivered to that user U and informs him/her that the advertiser A has put a new roof on the particular house, and the user U can then view the advertiser's work product if they desire. The advertisement can also include a parent location 14a (e.g. a brick-and-mortar address, a phone number, a website, etc.) to contact the advertiser A for a quote and to redeem the advertisement (which could be a discount). In this regard, the parent and child locations 14a,14b can be used to create an “electronic yard sign.”

It is anticipated that the advertiser A can set up as many parent and child locations 14a,14b as desired in order to tailor its advertising campaign to suit its needs and its budget. The child location 14b can also be set up in random locations of high traffic (foot, auto, etc.) to maximize the viewing audience. Using child locations in this manner can be thought of as using one's mobile device 12 as a billboard. Once the user U of the mobile device 12 enters the child location 14b and receives the advertisement, at their discretion they can then be optionally provided with GPS directions (using an appropriate application on the mobile device 12) to the nearest parent location 14a to redeem the ad. If the parent location 14a is an online-only location, the application 18 can then load the web browser on the mobile device 12 and download the appropriate webpage of the advertiser A. If the parent location 14a is both an online location and a brick-and-mortar location, then the user U can be given both options for their choosing, or be directed to either of the two locations as decided by the advertiser A. It is to be appreciated that by utilizing the geographic locations 14 as parent and child locations 14a,14b, the advertiser A is able to yet further customize its advertising campaign. Although the parent and child locations 14a,14b can be configured in any number of ways, it is thus shown how they can be set up to effectively place a billboard outside its competitors' doors or to draw attention to an example of the advertiser's work product.

Optionally, the advertisement can be delivered to the mobile device 12 at a predetermined time before the mobile device 12 (and the user) approaches a retail destination (or any other specified location) which is providing the advertisement. The speed of the mobile device 12 can be readily determined by calculating its change in position over intervals of time, and therefore predicted velocities in the near future (or time until arrival at the location 14) can be determined as well. Based on the known and predicted future velocities, the advertisement can be delivered to the mobile device 12 at a predetermined amount of time before the user approaches the retail destination. In this regard, the boundary, or size, of the geographic location 14 (i.e., point of delivery of the advertisement to the mobile device 12) is a function of the speed of the mobile device 12.

For example, if the user U is walking in a mall, the geographic location 14 might only be a thirty foot perimeter around the advertiser's store entrance. There the advertisement A will be delivered to the mobile device 12 just shortly before the user U approaches the store entrance. In another example, when the user U is traveling down the highway, the geographic location 14 could be set up to deliver the advertisement A to the mobile device 12 two miles before the user U approaches the off-ramp to the retail destination.

In one embodiment of how the advertisement can be delivered to the mobile device 12 in this manner, the mobile device 12, the application 18, and the interface 20 can coordinate to: (1) determine the mobile device's 12 estimated time until arrival using factors such as known current speed and estimated future traffic slow downs (which could be due to traffic, intersections, etc.); (2) determine the appropriate size, or boundary, of the geographic location 14 based upon the mobile device's 12 estimated time until arrival and as specified by the advertiser's parameters 13; and (3) deliver the advertisement to the mobile device 12 when the mobile device 12 has entered the geographic location 14. According to this method, the size/boundary of the geographic location 14 is dictated by the estimated time before arrival that the advertiser A would like the advertisement to be delivered.

In another embodiment, the geographic location 14 can vary by distance (either an actual travel distance or as the crow flies) rather than by using an estimated time until arrival. For example, the parameter 13 could be set up to deliver the advertisement to mobile device's 12: traveling 55 miles per hour or more at a distance of two miles; traveling 40-54 miles per hour at a distance of one mile; and traveling 39 miles per hour or less at a distance of one-half mile. Again, this is just an example of how this feature can work.

In this regard, this feature and the geographic location 14 can be combined so that the advertisement is delivered to the mobile device 12 at a predetermined time before the mobile device 12 approaches the retail destination itself. It is to be understood that the predetermined amount of time that is intended to lapse first can be fully customized as well. Depending upon the user's ability to slow down their speed or turn around, the predetermined amount of time could be about 30 seconds to about 2 minutes.

In this regard, the limits of the present invention can become boundless. Examples of use of the present invention can include mobile ads for sales on sporting event ticket prices transmitted to males aged 18-50 within a 10 mile radius of the stadium, or advertisements from furniture retailers on the weekend to young married couples within a specific time period after the couple is believed to have received their tax refund.

The present invention could also be applicable for use as a public service announcement. For instance, when approaching a shopping mall, a message could be received indicating which portions of the parking lot have the most available spaces, or which stores are offering sales and the contents of those individual advertisements. It is anticipated that as technology continues to progress, the possibilities for using the present invention will continue to grow as well.

Yet another parameter 13 which can be utilized for use herewith is the actual velocity of the mobile device 12 itself. That is, in order for the advertiser A to ensure that it is sending the advertisement to its intended audience, the advertiser A can specify that the ad is delivered only to those mobile devices which have a velocity within the required range as it approaches and/or enters the geographic location 14. For instance, if the advertiser's location is near a highway and it desires to use the advertisement to only attract customers off the highway, the advertiser can require that the mobile device's speed be at least 55 miles per hour. Likewise, if the advertiser is in a mall and it is only interested in using the advertisement to attract foot traffic, it can dictate that it will only send advertisements to mobile devices traveling at 10 miles per hour or less. It is understood by one having ordinary skill in the art that this parameter 13 can be configured to have a minimum speed, a maximum speed, or both a minimum and maximum to capture mobile devices traveling within a specified range of speed.

Another optional feature of the application 18 is to track and record the users' geographic history or patterns. In this regard, an additional parameter 13 can be to allow an advertiser to specify that its ads are delivered only to users who have their desired target traffic history based on the number, or frequency, that the user U is within the geographic location. For example, an advertiser A can specify that it would like its ad delivered only to a mobile device 12 which has never been to the specified location before in an effort to attract a new customer. In another example, an advertiser A can specify that it would only like to deliver the ad to users U once every five times that the user U is within the geographic location 14. In yet another example, the advertiser A can specify that it would only like the advertisement delivered to those users which have been within the geographic location 14 at least a specific number of times, or to users who are within the geographic location 14 at least three times per week. It is to be appreciated that this is yet another feature which can be used to fully customize and configure the advertising campaign by the advertiser A, and that any imaginable delivery setting can be specified by the advertiser A.

Transmission of the advertisement to the mobile device 12 is accomplished using any suitable means which are well-known in the art, such as transmission of data over a 3G or 4G network, or transmission as an SMS text message. Specifically, the mobile device 12 can monitor and periodically transmit its location to the web-based interface 20 over the telecommunication network. As the mobile device 12 enters into the defined geographic location 14, the interface 20 transmits the advertisement to the mobile device 12. As discussed above, the advertising campaign can be configured using the interface 20 so that the advertisement is only transmitted to the mobile device 12 when all of the parameters 13 are present, e.g., the user U is of the specified sex and/or age range.

In addition, when an advertising campaign is first initialized, the interface 20 will transmit the ad to any mobile device 12 already located within the geographic location 14 which fit any other parameters required by the advertiser A. The advertisement can also be configured for delivery to the user U at specific times of day, such as during business hours.

In order to maximize the efficiency of the advertising campaign, an incentive 16 can be provided to the user U. The incentive 16 can be provided to the user U at any time as specified by the user U according to the parameters 13. For example, the incentive 16 can be delivered when the mobile device 12 received the ad, after the user U views the ad, after the user U redeems the ad, after the user U provides feedback on the ad, and so forth. The incentive 16 can comprise anything of known value to the user U which the user U will receive. Preferably, the incentive 16 includes a monetary payment to the user U from the advertiser A. The payment could be made directly into the user's bank account, applied toward a credit card account, applied toward an account managed by the interface provider, applied to an online payment service such as PayPal®, forwarded to a charity, and so forth. Regardless of how the incentive 16 is delivered to the user U, in a specific example, the incentive 16 is a monetary payment to the user U which the user U can withdraw as a cash payment.

It is anticipated that the interface provider could charge a fee for the mobile advertising service to the advertisers, and at least some portion of this fee would be used to pay the users for viewing the advertisements.

The incentive 16 could alternatively include the accumulation of points toward a point-based rewards system operated by the interface provider. For example, five points could be awarded for the viewing of each advertisement, and the points can be accrued toward a number of different goods within a points catalog. It is thought that such a points catalog could be maintained and operated by the service provider. In this regard, points could be exchanged for small rewards, such as a $5 voucher for food at a restaurant, or saved for large point items like a computer, airline ticket vouchers, etc. In this example, a portion of the fees paid by the advertisers to the interface provider could be used to provide for the rewards. The incentive 16 could also include a coupon or discount of known value to a known retailer.

It is understood by one having ordinary skill in the art that it is not necessarily important what the incentive 16 is, rather that it is known to have a value to give the user U a legitimate motivation to view the ad in the first place. Also, the user U does not necessarily need to know the actual value of the incentive, but only that the incentive 16 has an actual value. Once the user U has viewed the ad, it is then up to the effectiveness of the ad to complete the sale.

As stated above, the incentive 16 can be delivered to the user U for viewing the ad, otherwise the incentive can be delivered to the user U for simply receiving the ad on his or her mobile device 12 (prior to actually viewing it).

Optionally, a particular action can be required of the user U beyond viewing the ad in order to receive the incentive. For instance, the user U may be required to provide feedback on the ad, such as by giving the ad a rating using a system that is integrated into the application 18. For example, the rating system could be assigning the ad either a “thumbs up” or a “thumbs down.” The rating system could also include rating the ad using a “star system,” such as giving an ad three out of four stars. The feedback could also include leaving a comment. Any suitable type of rating system which is well-known could be used.

In yet another possibility, the rating could actually be generated by the application 18 and the interface 20 based on factors like the number of ad redemptions, the percentage of ads being redeemed versus the number of ads delivered, the average amount of time that passes between receiving the ad and redeeming the ad (when redeemed), etc.

In a second embodiment hereof, the present invention provides a method of delivering an advertisement to at least one mobile device 12 which generally comprises: (a) transmitting the advertisement to any provided mobile device 12; and (b) providing the incentive 16 of known value to the user U of the mobile device 12 for viewing the advertisement. According to this embodiment, the advertisement could be transmitted to any mobile device 12 which is configured to receive the advertisement. The user U could still receive the incentive 16 for viewing the advertisement; however, the advertisement does not necessarily need to be limited to the specific geographic location 14. Stated otherwise, the parameter for the geographic location 14 for this advertisement would be everywhere, or selected as “non-limiting.”

In a third embodiment hereof, the present invention provides a method of delivering an advertisement to at least one mobile device 12 which generally comprises: (a) defining the geographic location 14 for delivery of the advertisement; (b) transmitting the advertisement to each mobile device 12 which enters into the geographic location 14; and (c) providing the incentive 16 to the user U of the mobile device 12 for viewing the advertisement.

This is similar to the first embodiment described above; however, this embodiment pertains to transmitting the advertisement to the mobile device 12 upon the user's entry into the geographic location 14. For any geographic location 14 which is particularly small, this embodiment is of particular relevance. For instance, the geographic location 14 could be defined as within 30 feet of a storefront in a shopping mall. As people continually enter and exit the geographic location 14, the application 18 and the interface 20 should be capable of reacting as quickly as possible and providing the user U with the advertisement as soon as the mobile device 12 has entered the geographic location 14.

In a fourth embodiment hereof, the present invention provides a method of delivering an advertisement to at least one mobile device 12 which generally comprises: (a) defining the geographic location 14 for delivery of the advertisement; (b) transmitting the advertisement to any provided mobile device 12 located within the geographic location 14; and (c) transmitting the advertisement to each mobile device 12 which enters into the geographic location 14. According to this embodiment, the user U is not provided with the incentive 16 for viewing the ad. Instead, the success of this embodiment would rely upon the advertiser's ability to transmit only those ads that are of legitimate interest to the user U, and/or the user's ability to specify the types of goods or services (or even the specific companies) for which they are interested in seeing ads for.

In a fifth embodiment hereof, the present invention provides a method of delivering an advertisement to at least one mobile device 12 which generally comprises: (a) transmitting the advertisement to any provided mobile device 12; and (b) displaying a dynamic countdown 22 to an expiration of the advertisement on the mobile device 12. The dynamic countdown 22 can comprise a digital countdown displaying any of the following: the number of weeks, days, hours, minutes, or seconds until the advertisement expires. Preferably, the dynamic countdown 22 is displayed on the advertisement, or it is visually integrated with the advertisement in any other suitable manner so that the dynamic countdown 22 is readily viewed while viewing the advertisement.

Alternatively, expiration of the ad can occur after a predetermined number of advertisements have been redeemed. For instance, the advertisement can be sent to the first 1,000 mobile devices 12 which qualify for reception of the ad (based upon any number of possible factors such as demographics, location, etc.). After 100 advertisements have been redeemed, the advertisement then automatically expires from each mobile device 12 which has received but not yet redeemed the ad. In this regard, the countdown 22 can work interactively to periodically update the number of remaining advertisements that can be redeemed, and give the user a running tally of how many advertisements are yet to be redeemed. In this regard, the “running tally” of redeemed ads can give the user U an idea of how quickly the expiration is approaching, and also create a sense of urgency to redeem the ad before the all of the permitted ads have been redeemed.

In a sixth embodiment hereof, the present invention provides a method of delivering an advertisement to at least one mobile device 12 which generally comprises: (a) transmitting the advertisement to any provided mobile device 12; (b) displaying an ad image on the mobile device 12, the ad image including information relevant to the advertisement to inform the user U as to the content and expiration date of the advertisement; and (c) displaying a redeem image on the mobile device 12, the redeem image including redemption information necessary to redeem the advertisement.

According to this embodiment, the advertisement initially provides sufficient information to the user U to allow the user U to determine whether he/she will redeem, or use, the ad. If the user U has decided to redeem the ad, he/she then can select for their mobile device 12 to display a redeem image which includes information necessary to redeem the advertisement. Optionally, the redeem image may be viewable for a finite amount of time, and may also optionally not be viewable again if the user U navigates away from the redeem image on the mobile device 12.

The advertisement can also be set up so that the redeem image can only be viewable when the GPS on the mobile device 12 has been turned on and is within a specified distance of a redeem location (e.g. the advertiser's brick-and-mortar establishment). In this regard, the location of the mobile device 12 can optionally be tracked for verification and data-gathering purposes.

As described in further detail below, the user U does not have an opportunity to spam or illicitly distribute the ad to others without the advertiser's consent or authority. Companies which engage in coupon advertising campaigns know that coupon abuse widely exists. The threat of coupon abuse is a deterrent from even offering coupons for many manufacturers and retailers. By providing a secure safeguard against the spamming of the advertisements, the advertiser is provided with insurance that it can control the number of advertisements which are honored.

The ad image can contain any information which is relevant to the advertisement for allowing the user U to determine if he or she would like to redeem the ad. For instance, basic information like where the ad can be redeemed and the nature of what is being offered. It can also include information such as the distance from the redemption location, an expiration date or time (which can be a static date and/or time, or an interactive countdown timer), information pertinent to the incentive for viewing the ad (e.g., amount to be paid to the user U), the amount of time that the redeem image will be displayed if they choose to redeem the ad, and so forth.

The redeem image can include any of the same information as the ad image. But it also can include redemption information which is necessary to redeem the ad and which is not displayed on the ad image. The redemption information can include a bar code, a promotional code, any other suitable known type of scan code (e.g. a QR code), a confirmation screen which can include redemption information unique to the user U, and so forth.

In use, the user U is provided with the advertisement in a manner described above. The user U receives the ad image and first views the ad image. If the ad image is not viewed within a set time (e.g. 24 hours), then the ad image can be deleted from the phone by the application 18. Once the ad image has been viewed, the ad then moves onto a compiled list with other valid ads which can be redeemed. Assume, for example, that the user U decides that he or she would like to redeem the ad. For instance, the ad image might say that once the user U selects the redeem image, that the redeem image will only be viewable on the mobile device for two minutes. This limited time will help prevent spamming of the ad. The user U can then arrive at the advertiser's location and select the item for purchase.

Upon checking out or paying, the user U can then select to view the redeem image for the minimal amount of time that is required to actually scan a bar code on the phone, enter a promotional code, etc. In addition, part of redeeming the ad may be a requirement that the user U actually shows the redeem image to an employee at the point of purchase. The purchase can be any typical type of sale, such as over the Internet, over the phone, in person, etc. Obviously the nature of the redeem image will be in accordance with the type of sale taking place, for instance, providing a promotional code for phone or Internet sales.

By allowing the user U to view the redeem image for only a brief amount of time, and especially in instances where the user U is standing at a checkout counter in front of a sales associate, the user U will be very limited in his or her ability to illicitly distribute the redeem image to others.

Alternatively, an advertisement can be set up so that the single advertisement can be redeemed multiple times. But in this event, the redeem image preferably is recalled or reloaded onto the phone each time the ad is redeemed.

In order to further deter spamming of the redeem image, the application 18 can be configured so that the redeem image will no longer be available as soon as it is navigated away from, such as by a user U opening up a screenshot application to copy and spam the ad.

Optionally a warning screen can be provided when a user U initially selects to view the redeem image to fully inform the user U that they are going to navigate to the screen for a short period of time and that they will not be able to return to that screen either upon expiration or if they navigate away from it.

Optionally, the redeem image can further include any number of actions associated with it in order to redeem the ad. For instance, the redeem image may require the user U to click the redeem image to place a call, to be directed to a URL, to view a video, to listen to a song, to scan a code at the store, etc. The code could be a bar code, a QR code, a proprietary code, or any other suitable type of code which is developed for suitable use herewith. Once the code has been scanned by the phone, the advertisement can them be redeemed for value.

Furthermore, yet another optional component is to provide a verification device at the point of purchase. The verification device can use a bar code scanning operation or other suitable verification process that can be employed to guarantee that the mobile device 12 is actually at the location. In this regard, the advertiser can further safeguard against coupon abuse by ensuring that only users U at the proper location are redeeming the advertisement, if so desired by the advertiser. Preferably, the advertiser A can have a suitable device on-site for scanning and sensing the presence of the mobile device 12. This can be accomplished using any suitable sort of means for communication, but is preferably a wireless connection which can be quickly, easily, and safely established, such as using WiFi, Bluetooth®, Near Field Communication (or “NFC”), or any other suitable type of communicating between devices which is either known or developed in the future. Thus, this feature can further guarantee advertisers that only authorized users are participating in the advertisement.

Optionally, the advertisement can be configured to operate in which the redeem (or ad) image is first displayed on the mobile device 12 only after the mobile device 12 is sensed by the advertiser's on-site device via WiFi, Bluetooth®, NFC, or the like.

In accordance with using the mobile device 12 to communicate directly with an on-site device at the advertiser's location, optionally the mobile device 12 can be configured to use NFC or similar technology to apply the user's actual account balance with the service provider the toward the purchase. In this regard, any funds that the user U receives for viewing the ad in the first place could later be further applied toward the advertisement to purchase the good or service for a further reduced price.

It is to be appreciated by one having ordinary skill in the art that the present invention provides an efficient and versatile means for providing advertisements to the user U. The present invention is virtually limitless in the ways it can be customized by an advertiser A to deliver its ad campaign. The incentive system further ensures that the user U views the ad, and the advertiser A can select parameters to ensure that they are only providing the ad to their intended audience.

Moreover, the present invention provides a complete tracking system that allows an advertiser A to see who is viewing its ad, where the ad is being viewed, who is redeeming the ad, when the ad is being viewed and/or redeemed, and so forth. In this respect, the present invention allows an advertiser A to track the effectiveness of its advertising campaign with an unprecedented level of specificity. The advertiser A is thereby easily able to quantify the productive output of the ad and allow the advertiser A to easily modify the parameters 13 to maximize its return on investment. Obtaining information like this through traditional advertising and coupons can be very costly, if not impossible.

As is apparent from the preceding, the present invention provides a method of delivering effective mobile advertising to a mobile device within a pre-defined geographic location by providing the user with an incentive of known value for viewing the advertisement.

What is claimed is:

1. A method of delivering an advertisement to at least one mobile device which comprises:
(a) providing a software application which is operable on the at least one mobile device;
(b) defining a boundary of a geographic location;
(c) transmitting the advertisement to the at least one mobile device operating the software which is located within the geographic location; and
(d) providing an incentive to a user of at least one mobile device which has received the advertisement.

2. The method of claim 1 wherein the incentive being provided to the user is a monetary payment.

3. The method of claim 1 wherein the boundary of the geographic location is a function of the speed of each mobile device.

4. The method of claim 1 wherein the incentive being provided to the user is triggered by the user viewing the advertisement on the mobile device.

5. The method of claim 4 including the step of displaying, on the mobile device, a countdown until expiration of the ad.

6. The method of claim 1 wherein the incentive being provided to the user is triggered by the user providing feedback of the advertisement on the mobile device.

7. The method of claim 6 including the step of displaying, on the mobile device, a countdown until expiration of the ad.

8. The method of claim 1 including the step of directing the user of the at least one mobile device to a parent location to redeem the advertisement.

9. A method of delivering an advertisement to at least one mobile device which comprises:
(a) providing a software application which is operable on the at least one mobile device;
(b) transmitting the advertisement to the at least one mobile device operating the software; and
(c) providing a monetary payment incentive to a user of at least mobile device which has received the advertisement.

10. The method of claim 9 wherein the incentive being provided to the user is triggered by reception of the advertisement by the mobile device.

11. The method of claim 9 wherein the incentive being provided to the user is triggered by the user viewing the advertisement on the mobile device.

12. The method of claim 11 including the step of displaying, on the mobile device, a countdown until expiration of the ad.

13. The method of claim 9 wherein the incentive being provided to the user is triggered by the user providing feedback of the advertisement on the mobile device.

14. The method of claim 13 including the step of displaying, on the mobile device, a countdown until expiration of the ad.

15. The method of claim 9 including the step of displaying, on the mobile device, a countdown until expiration of the ad.

16. A method of delivering an advertisement to at least one mobile device which comprises:
(a) providing a software application which is operable on the at least one mobile device;
(b) defining a boundary of a geographic location associated with each provided mobile device operating the software application, the boundary for each mobile device being defined as a function of the speed of that particular mobile device;
(c) transmitting the advertisement to at least one mobile device operating the software application which enters the geographic location.

17. The method of claim 16 further including the steps of:
(d) displaying an ad image on at least one mobile device which has received the advertisement, the ad image including information relevant to the advertisement to inform a user as to the content and expiration date of the advertisement; and
(e) displaying a redeem image on at least one mobile device which has received the advertisement, the redeem image containing redemption information necessary to redeem the advertisement.

18. The method of claim 16 including the step of providing an incentive to a user of at least one mobile device which has received the advertisement.

19. The method of claim 16 including the step of displaying, on the mobile device, a countdown until expiration of the ad.

20. A method of delivering an advertisement to at least one mobile device which comprises:
(a) providing a software application which is operable on the at least one mobile device;
(b) defining a boundary of a geographic location;
(c) transmitting the advertisement to the at least one mobile device operating the software which is located within the geographic location; and
(d) directing a user of the at least one mobile device to a parent location to redeem the advertisement.

21. The method of claim 20 including the step of providing an incentive to the user of at least one mobile device which has received the advertisement.

22. The method of claim 20 including the step of displaying a countdown until expiration of the advertisement on at least one mobile device which has received the advertisement.
